(19) United States
(12) Patent Application Publication
(10) Pub. No.: US 2016/0283479 A1
(43) Pub. Date: Sep. 29, 2016

(54) METHOD AND SYSTEM FOR MANIPULATING DATA

(71) Applicants: BEIJING JINGDONG SHANGKE INFORMATION TECNOLOGY CO., LTD., Haidian District, Beijing (CN); BEIJING JINGDONG CENTURY TRADING CO., LTD., Beijing (CN)

(72) Inventors: Yang XIAO, Haidian District, Beijing (CN); Xinrong LI, Haidian District, Beijing (CN); Liu LIU, Haidian District, Beijing (CN); Xi LIANG, Haidian District, Beijing (CN)

(21) Appl. No.: 15/035,661

(22) PCT Filed: Sep. 26, 2014
(86) PCT No.: PCT/CN2014/087620

§ 371 Date: May 10, 2016

(30) Foreign Application Priority Data
Nov. 13, 2013 (CN) 201310567862.8

(51) Int. Cl. G06F 17/30

(52) U.S. Cl. CPC G06F 17/3048; G06F 17/30327; G06F 17/30595

(57) ABSTRACT

The invention provides a method and system for operating data, which can improve efficiency of a user operating data having a tree structure. The method comprising: locating a first cache server in a distributed cache system after receiving a data operation request from a user; the first cache server constructing a cache tree in its own memory in accordance with information of relation between a file or folder and its parent directory in a relational database, the cache tree saving data below a root node corresponding to data specified by the data operation request in a tree structure; and locating a node where the data specified by the data operation request saved in the cache tree is located, and then operating the data in the node and returning an operation result to the user.

### TECHNICAL FIELD

The invention relates to a computer network technical field and, in particular, to a method and system for operating data.

### BACKGROUND

A computer network generally has a data source based on a tree structure, e.g., various folders and files therein in a file service. An existing solution for locating a file is to save node information of the file in a relational database, in addition to data of the file itself, the relational database further saves information of a relation between the file or folder and its parent directory, and a user can find the parent directory where the file or folder is located through a file or folder identification, and thereby can further trace back to a root directory.

In the case of a very large data volume, a reading and writing speed of the relational database is slow, thereby it influences efficiency of a user operating data.

### SUMMARY OF THE INVENTION

In view of this, the invention provides a method and system for operating data, which can improve efficiency of the user operating data having a tree structure.

In order to achieve the above objective, according to one aspect of the invention, a method for operating data is provided.

The method for operating data of the invention comprises: locating a first cache server in a distributed cache system after receiving a data operation request from a user; the first cache server constructing a cache tree in its own memory in accordance with information of relation between a file or folder and its parent directory in a relational database, the cache tree saving data below a root node corresponding to data specified by the data operation request in a tree structure; and locating a node where the data specified by the data operation request saved in the cache tree is located, and then operating the data in the node and returning an operation result to the user.

Optionally, the flow of constructing a cache tree in its own memory comprises: step A: determining the root node corresponding to the data specified by the data operation request, and saving the root node in a stack; step B: judging whether or not the stack is empty, if so, stopping the flow, otherwise entering step C; step C: taking a node at a stack top out of the stack; step D: judging whether or not the node taken out of the stack is a leaf node, if so, returning to the step B, otherwise entering step E; and step E: acquiring all sub-nodes of the node taken out of the stack in the step C in the relational database in accordance with the information of the relation, saving the sub-nodes below the node taken out of the stack in the step C in the cache tree, saving the sub-nodes in the stack, and then returning to the step B.

Optionally, the step of operating the data in the node comprises: reading/writing the data in the node, or deleting the data in the node, or newly adding a sub-node to the node, or renaming the node, or moving the node.

Optionally, the method further comprises saving a time stamp for operating the node in the cache tree.

Optionally, after the step of constructing the cache tree in its own memory, the method further comprises: saving a user identification of the user in the root node of the cache tree.

According to another aspect of the invention, a system for providing data is provided.

The system for providing data of the invention comprises: a locating module for locating a first cache buffer in a distributed cache system after receiving a data operation request from a user; a cache tree constructing module for constructing a cache tree in its own memory in accordance with information of a relation between a file or folder and its parent directory in a relational database, the cache tree saving data below a root node corresponding to data specified by the data operation request in a tree structure; and a providing module for locating a node where the data specified by the data operation request saved in the cache tree is located, and then operating the data in the node and returning an operation result to the user.

Optionally, the cache tree constructing module is further used for constructing the cache tree in accordance with the following flow: step A: determining the root node corresponding to the data specified by the data operation request, and saving the root node in a stack; step B: judging whether or not the stack is empty, if so, stopping the flow, otherwise entering step C; step C: taking a node at a stack top out of the stack; step D: judging whether or not the node taken out of the stack is a leaf node, if so, returning to the step B, otherwise entering step E; and step E: acquiring all sub-nodes of the node taken out of the stack in the step C in the relational database in accordance with the information of the relation, saving the sub-nodes below the node taken out of the stack in the step C in the cache tree, saving the sub-nodes in the stack, and then returning to the step B.

Optionally, the cache tree constructing module is further used for reading/writing the data in the node in the cache tree, or deleting the data in the node, or newly adding a sub-node to the node, or renaming the node, or moving the node.

Optionally, the system further comprises a time stamp module for saving a time stamp for operating the node in the cache tree.

Optionally the cache tree constructing module is further used for saving a user identification of the user in the root node of the cache tree.

According to the technical solution of the invention, the cache tree is constructed in the cache server in accordance with the file in the relational database, the data of the node in the cache tree is operated, and since reading and writing of a cache have a characteristic of a comparatively high speed, efficiency of operating data having a tree structure is improved. In addition, since the operation of the user after a login generally involves a plurality of nodes below one root node, and the constructed cache tree contains these nodes, efficiency of a user operating data in a plurality of nodes can be greatly improved in the case that the cache tree has been constructed.

### BRIEF DESCRIPTION OF THE DRAWINGS

Figures are used for better understanding the invention, and do not form improper limitations of the invention. Wherein:

FIG. 1 is a topological schematic diagram of a connection of various kinds of servers according to an embodiment of the invention;

FIG. 2 is a schematic diagram of a flow of constructing a cache tree according to an embodiment of the invention; and

FIG. 3 is a schematic diagram of main modules of a system for providing data according to an embodiment of the invention.

### DETAILED DESCRIPTION

The contents below give descriptions of exemplary embodiments of the invention by taking the figures into consideration, and the contents include various details of the embodiments of the invention to facilitate understanding, and shall be considered as exemplary ones only. Thus, those skilled in the art should realize that the embodiments described herein can be changed and modified in various manners without departing from the scope and spirit of the invention. Similarly, for clarify and conciseness, descriptions of common functions and structures are omitted in the descriptions below.

In the embodiment, a distributed cache system is adopted to cache data in a relational database. The data have a tree structure, and it is known to all that most of existing distributed caching techniques store data in a key-value manner, so in the embodiment, the cache server constructs, in accordance with the data in the relational database and an identification of a file or folder specified by a user, a cache tree containing the file or folder, then locates a node in the cache tree, and then operates the data in the node in accordance with a demand of the user, which comprises reading/writing the data in the node, or deleting the data in the node, or newly adding a sub-node to the node, or renaming the node, or moving the node.

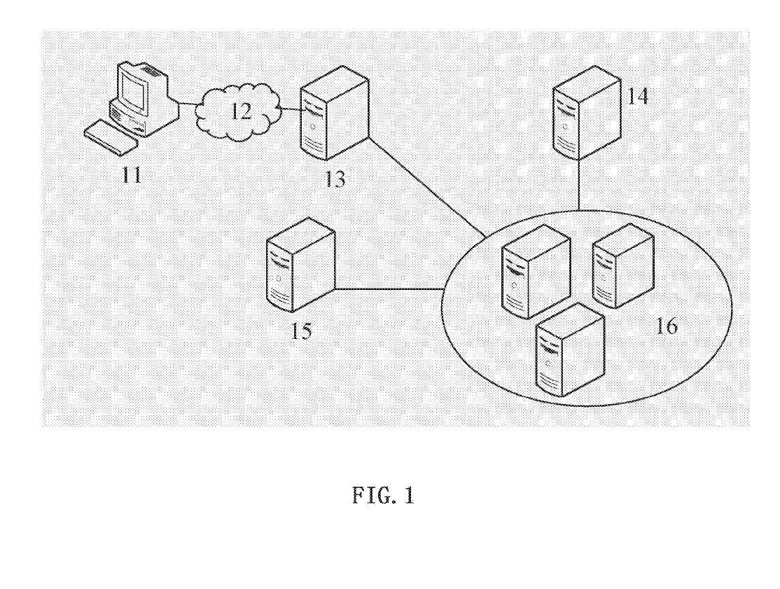

FIG. 1 is a topological schematic diagram of a connection of various kinds of servers according to an embodiment of the invention. A terminal device 11 used by the user sends a data operation request to an application server 13 through an internet 12, the application server 13 adopts a locating algorithm to locate a cache server, e.g., a cache server 161, from a cache server cluster 161, and then sends a data operation instruction to the cache server 161, the cache buffer 161 constructs a cache tree in accordance with data in a relational database, then a consistency control server 15 uses a consistency verification mechanism to verify whether or not the data to be operated by the user is the newest, operates the data in the node specified by the user in accordance with the data operation instruction after the pass of the verification, performs a persistence in the relational database, and returns operation result information to the application server 13, and the application server 13 provides the operation result information to the user.

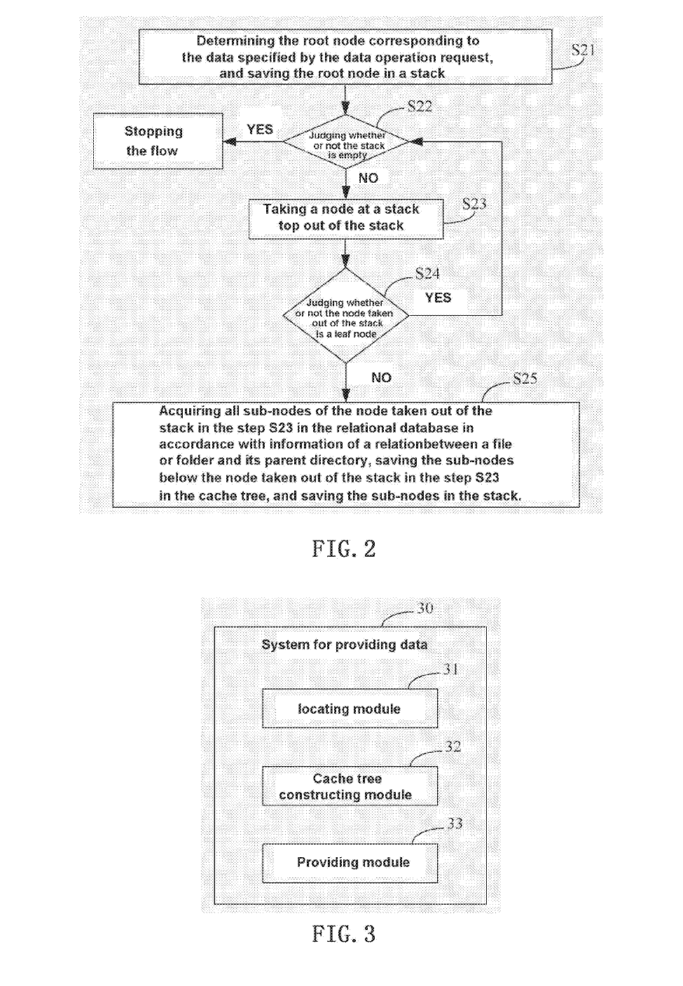

FIG. 2 is a schematic diagram of a flow of constructing a cache tree according to an embodiment of the invention. As shown in FIG. 2, the cache tree can be constructed by adopting the following flow:

Step S21: Determining the root node corresponding to the data specified by the data operation request, and saving the root node in a stack.

Step S22: Judging whether or not the stack is empty. If the stack is not empty, step S23 is entered, and if the stack is empty, which indicates that the cache tree has been constructed, the flow is stopped, and a user identification of the user can be saved in the root node.

Step S23: Taking a node at a stack top out of the stack.

Step S24: Judging whether or not the node taken out of the stack is a leaf node, if so, returning to the step S22, otherwise entering step S25.

Step S25: Acquiring all sub-nodes of the node taken out of the stack in the step S23 in the relational database in accordance with information of a relation between a file or folder and its parent directory, saving the sub-nodes below the node taken out of the stack in the step S23 in the cache tree, saving the sub-nodes in the stack, and then returning to the step S22.

When the step S22 is performed for the first time, since the root node is in the stack, the stack is not empty. Since the stack has a characteristic of first-in last-out, a node pushed in the stack last and its sub-nodes will firstly exist in the cache tree. For example, nodes B, C, D exist below a root node A, wherein the node D has sub-nodes D1, D2, and the nodes D1, D2 have no sub-nodes, i.e., they are leaf nodes, the data specified by the data operation request is in the node D1, then the root node A is determined in the step S21, the node D is pushed in the stack last in the step S25, and the node D is taken out of the stack after the step S23 is returned to; the sub-nodes D1, D2 of the node D are processed at the step S25, then the node C is processed, and at this time, the nodes D, D1, D2 are all existing in the cache tree.

In the case that the cache tree has been formed, it becomes very easy to look for a node. The circumstance where the nodes B, C, D exist below the root node A, wherein the node D has sub-nodes D1, D2 is still taken as the example, the root node where the user identification is located, i.e., the root node A, is found, then all the sub-nodes B, C, D of the root node A are acquired, then the sub-nodes are looked for below the nodes B, C, D, and finally the sub-node D1 is found below the node D. After an operation of the sub-node D1 is performed, a time stamp of the operation can be saved so as to be used for consistency verification.

FIG. 3 is a schematic diagram of main modules of a system for providing data according to an embodiment of the invention. As shown in FIG. 3, a system 30 for providing data mainly comprises a locating module 31, a cache tree constructing module 32, and a providing module 33. Wherein the locating module 31 can be disposed in the application server 13, and the cache tree constructing module 32 and the providing module 33 can be disposed in respective cache servers in the cache server cluster 16.

The locating module 31 is used for locating a first cache buffer in a distributed cache system after receiving a data operation request from a user; the cache tree constructing module 32 is used for constructing a cache tree in its own memory in accordance with information of relation between a file or folder and its parent directory in relational database, the cache tree saving data below a root node corresponding to data specified by the data operation request in a tree structure; and the providing module 33 is used for locating a node where the data specified by the data operation request saved in the cache tree is located, and then operating the data in the node and returning an operation result to the user.

The cache tree constructing module 32 can be further used for constructing the cache tree in accordance with the flow as shown in FIG. 2; can be further used for reading/writing the data in the node in the cache tree, or deleting the data in the node, or newly adding a sub-node to the node, or renaming the node, or moving the node; and in addition, can be further used for saving a user identification of the user in the root node of the cache tree.

The system 30 for providing data can further comprise a time stamp module (not shown) for saving a time stamp for operating the node in the cache tree. The time stamp module can be disposed in the consistency control server 15.

According to the technical solution of the embodiment of the invention, the cache tree is constructed in the cache server in accordance with the file in the relational database, the data of the node in the cache tree is operated, and since reading and writing of a cache have a characteristic of a comparatively high speed, efficiency of operating data having a tree structure is improved. In addition, since the operation of the user after a login generally involves a plurality of nodes below one root node, and the constructed cache tree contains these nodes, efficiency of a user operating data in a plurality of nodes can be greatly improved in the case that the cache tree has been constructed.

The contents above describe the basic principle of the invention by taking the embodiments into consideration, but it should be noted that those skilled in the art can understand all of or any of steps or components of the method and device of the invention, and can perform achievement in any computing apparatus (including a processor, a storage medium, etc.) or a network of a computing apparatus with a hardware, a software or a combination thereof. This can be achieved by those skilled in the art just by using their basic programming skills in the case of reading the descriptions of the invention.

Thus, the objective of the invention can be further achieved by running a program or a group of programs on any computing apparatus. The computing apparatus can be a common universal apparatus. Thus, the objective of the invention can be also achieved only by providing a program product containing a program code for achieving the method or apparatus. That is to say, such program product also forms the invention, and a storage medium storing such program product also forms the invention. Obviously, the storage medium can be any common storage medium or any storage medium to be developed in the future.

It should be further noted that in the device and method of the invention, it is obvious that the respective components or respective steps can be separated and/or recombined. These separations and/or recombinations shall be deemed as equivalent solutions of the invention. Furthermore, the steps for performing the above series of processes can be naturally chronologically performed in the described order, but are not necessarily chronologically performed. Some steps can be performed in parallel or independently of each other.

The above embodiments do not form limitations of the scope of protection of the invention. Those skilled in the art should understand that depending on requirements for design and other factors, various modifications, combinations, sub-combinations and substitutions can occur. Any modification, equivalent substitution, improvement and the like made within the spirit and principle of the invention shall be contained in the scope of protection of the invention.

1.-10. (canceled)

11. A method for operating data, characterized by comprising:
locating a first cache server in a distributed cache system after receiving a data operation request from a user;
the first cache server constructing a cache tree in its own memory in accordance with information of relation between a file or folder and its parent directory in a relational database, the cache tree saving data below a root node corresponding to data specified by the data operation request in a tree structure; and
locating a node where the data specified by the data operation request saved in the cache tree is located, and then operating the data in the node and returning an operation result to the user.

12. The method for operating data according to claim 11, characterized in that the flow of constructing a cache tree in its own memory comprises:
step A: determining the root node corresponding to the data specified by the data operation request, and saving the root node in a stack;
step B: judging whether or not the stack is empty, if so, stopping the flow, otherwise entering step C;
step C: taking a node at a stack top out of the stack;
step D: judging whether or not the node taken out of the stack is a leaf node, if so, returning to the step B, otherwise entering step E; and
step E: acquiring all sub-nodes of the node taken out of the stack in the step C in the relational database in accordance with the information of the relation, saving the sub-nodes below the node taken out of the stack in the step C in the cache tree, saving the sub-nodes in the stack, and then returning to the step B.

13. The method for operating data according to claim 11, characterized in that the step of operating the data in the node comprises: reading/writing the data in the node, or deleting the data in the node, or newly adding a sub-node to the node, or renaming the node, or moving the node.

14. The method for operating data according to claim 13, characterized by further comprising saving a time stamp for operating the node in the cache tree.

15. The method for operating data according to claim 11, characterized in that after the step of constructing a cache tree in its own memory, the method further comprising saving a user identification of the user in the root node of the cache tree.

16. The method for operating data according to claim 12, characterized in that after the step of constructing a cache tree in its own memory, the method further comprising saving a user identification of the user in the root node of the cache tree.

17. The method for operating data according to claim 13, characterized in that after the step of constructing a cache tree in its own memory, the method further comprising saving a user identification of the user in the root node of the cache tree.

18. The method for operating data according to claim 14, characterized in that after the step of constructing a cache tree in its own memory, the method further comprising saving a user identification of the user in the root node of the cache tree.

19. A system for providing data, characterized by comprising:
a locating module for locating a first cache buffer in a distributed cache system after receiving a data operation request from a user;
a cache tree constructing module for constructing a cache tree in its own memory in accordance with information of relation between a file or folder and its parent directory in a relational database, the cache tree saving data below a root node corresponding to data specified by the data operation request in a tree structure; and
a providing module for locating a node where the data specified by the data operation request saved in the cache tree is located, and then operating the data in the node and returning an operation result to the user.

20. The system for providing data according to claim 19, characterized in that the cache tree constructing module is further used for constructing the cache tree in accordance with the following flow:
step A: determining the root node corresponding to the data specified by the data operation request, and saving the root node in a stack;
step B: judging whether or not the stack is empty, if so, stopping the flow, otherwise entering step C;
step C: taking a node at a stack top out of the stack;
step D: judging whether or not the node taken out of the stack is a leaf node, if so, returning to the step B, otherwise entering step E; and
step E: acquiring all sub-nodes of the node taken out of the stack in the step C in the relational database in accordance with the information of the relation, saving the sub-nodes below the node taken out of the stack in the step C in the cache tree, saving the sub-nodes in the stack, and then returning to the step B.

21. The system for providing data according to claim 19, characterized in that the cache tree constructing module is further used for reading/writing the data in the node in the cache tree, or deleting the data in the node, or newly adding a sub-node to the node, or renaming the node, or moving the node.

22. The system for providing data according to claim 21, characterized by further comprising a time stamp module for saving a time stamp for operating the node in the cache tree.

23. The system for providing data according to claim 19, characterized in that the cache tree constructing module is further used for saving a user identification of the user in the root node of the cache tree.

24. The system for providing data according to claim 20, characterized in that the cache tree constructing module is further used for saving a user identification of the user in the root node of the cache tree.

25. The system for providing data according to claim 21, characterized in that the cache tree constructing module is further used for saving a user identification of the user in the root node of the cache tree.

26. The system for providing data according to claim 22, characterized in that the cache tree constructing module is further used for saving a user identification of the user in the root node of the cache tree.
